(19) United States
(12) Patent Application Publication
(10) Pub. No.: US 2018/0335408 A1
(43) Pub. Date: Nov. 22, 2018

(54) COMBINED FLUORESCENCE AND ABSORPTION DETECTOR FOR ON-COLUMN DETECTION AFTER CAPILLARY SEPARATION TECHNIQUES

(71) Applicant: Brigham Young University, Provo, UT (US)

(72) Inventors: Paul B. Farnsworth, Orem, UT (US); Milton L. Lee, Pleasant Grove, UT (US); Luke T. Tolley, Mapleton, UT (US); H. Dennis Tolley, Mapleton, UT (US); Xiaofeng Xie, Provo, UT (US)

(21) Appl. No.: 15/984,042

(22) Filed: May 18, 2018

Related U.S. Application Data
(60) Provisional application No. 62/508,239, filed on May 18, 2017.

(51) Int. Cl. G01N 30/78; G01N 21/33; G01N 21/31; G01N 21/64; G01N 30/74

(52) U.S. Cl. CPC G01N 30/78; G01N 21/33; G01N 21/3103; G01N 21/645; G01N 2201/0642; G01N 2021/6478; G01N 2201/062; G01N 2201/0668; G01N 30/74

(57) ABSTRACT

A system and method for performing UV LED-based absorption detection for capillary liquid chromatography for detecting and quantifying compounds in a liquid, wherein a simplified system eliminates the need for a beam splitter and a reference cell by using a stable UV source, and power requirements are reduced, resulting in a portable and substantially smaller system with relatively low detection limits.

### BACKGROUND

### Description of Related Art

A variety of techniques for separation of mixtures of compounds rely on compounds moving through a channel or tube (referred to as a column), with the compounds emerging as a series of bands at the end of the column. Detection and identification of the compounds in the bands as they emerge from the separation column are essential steps in a successful separation technique.

An effective detection scheme should not degrade the separation that has already occurred in the separation column. Unfortunately, the addition of flow cells or other attachments to the separation column, especially for columns with capillary dimensions, generally degrades the separation. Thus, detection directly on the separation column may be more desirable.

Two spectroscopic techniques that have been used effectively for detection in condensed-phase separations are absorption spectrophotometry and fluorescence spectrometry. The strength of absorption spectrophotometry may lie in the fact that almost all molecules absorb, so this method may be a nearly universal detector that will respond to most compounds. The information provided by the absorption detector is the magnitude of absorbance at one or more wavelengths of light. However, the absorption detector's liabilities are its lack of specificity and relatively poor sensitivity.

In contrast, Fluorescence spectrometry may be less universal than spectrophotometry because fluorescence quantum yields may vary widely among different classes of compounds, and some compounds do not fluoresce. For compounds with high quantum yields, fluorescence spectrometry may be exceptionally sensitive, capable of detecting single molecules.

The information provided by a fluorescence detector is different than that provided by a spectrophotometric detector. The fluorescence wavelengths depend on molecular structure, and the signal magnitude depends on quantum efficiency and concentration.

Because the two modes of detection provide different information, combining the two may significantly add to the specificity with which a molecule can be identified. The value of combining fluorescence spectrometry and spectrophotometry in a single detector has been recognized and exploited by researchers in the past. A dual mode detector was described in 1975, and a different approach was reported in 1999. However, both of these detectors used bulky gas discharge lamps and both required additions at the end of a separation column. Furthermore, neither was suitable for on-column detection, particularly for capillary column separations.

A prior art Liquid chromatography (LC) system may be modified to include both of these types of detectors. Accordingly, it may be useful to examine an LC absorption system and determine how that system might be modified to include two detectors.

Liquid chromatography (LC) is performed in order to analyze the contents of chemicals in a liquid solution. FIG. 1 is a diagram showing the major elements of the prior art system that may be modified to function as part of the present invention.

Before beginning, it should be understood that on-column detection may refer to when packed bed material terminates before the end of the column so that the last part of the column is actually empty. But there may also be situations in which the column has packed bed material all the way to the end of the column and a capillary has to be added in order to perform detection in the capillary portion.

Accordingly, the embodiments of the invention should all be considered to include both configurations to be within the scope of all embodiments, where detection is taking place on-column in an area of the column that does not contain packed bed material, or within a capillary that has been added to the very end of the column where the packed bed material ends.

FIG. 1 shows an LED-based UV absorption detector with low detection limits for use with capillary liquid chromatography. In this system, LED output wavelength may change with changes in drive current and junction temperature. Therefore, LEDs should be driven by a constant current supply, and heating of the system should be avoided.

The quasi-monochromaticity of the LED source contributes to stray light in the system, leading to detector non-linearity. Any detection system may be protected from any LED light outside the desired absorption band by employing a filter in the system.

On-column capillary detection may be preferred for capillary columns, since narrow peak widths are obtained by eliminating extra-column band dispersion, and peak resolution is maintained. The short-term noise in the detector may determine the detection limits and may be generally reduced by performing integration, smoothing, and/or using low-pass RC filters.

FIG. 1 shows that further optimization of the detector design and reduction in the noise level may lead to better detection limits for small diameter capillary columns. The elements of the system in FIG. 1 include a UV-based LED 40, a first ball lens 42, a band-pass filter 46 that may be tuned to the LED 40 light source, a second ball lens 48, a slit 50 that may be comprised of razor blades, a capillary column 52 that may have an inner diameter (ID) of approximately 150 μm and an outer diameter of approximately 365 μm, and a silicon photodiode detector 54.

The scale of the elements of the invention are not shown in FIG. 4. The UV light from the second ball lens 48 may be converging much more sharply than shown. Furthermore, the diameter of the second ball lens 48 may be more than 10 times larger than the inner diameter of the capillary column 54.

Accordingly, it should be understood that FIG. 4 is provided to show the physical order of the components of the invention without showing the actual sizes.

In addition, it should be understood that any drawings of the convergence of UV light caused by the first and second ball lenses 42, 48 is not being shown to scale and is for illustration purposes only.

It may be possible to provide the same functionality as the components of the detection system listed above by substituting other components that provide the same function. For example, while a first and second ball lens 42, 48 are shown in FIG. 4, a different type of lens may be substituted and should still be considered to fall within the scope of the first embodiment. It may also be possible to provide the functionality of the first two ball lenses using a single lens and obtain the desired focusing effect. It should also be understood that the values to be given for all aspects of the first embodiment are approximate only and may vary up to 50% without departing from the desired functionality of the first embodiment.

FIG. 2 is a cut-away profile view of the system shown in FIG. 1 but with more construction detail. This system shown in FIG. 2 should not be considered as limiting, but as a demonstration of the principles of the design. Accordingly, specific values given for size, shape, weight, power, sensitivity or any other characteristics of components are for example only and may vary from the values given.

FIG. 2 shows an LED 40 having a first ball lens 42. The LED 40 may be disposed within an LED holder 44. The LED 40 may be manufactured as integrated with the first ball lens 42, or it may be attached or disposed adjacent to the first ball lens 42 after manufacturing. The LED 40 may be selected from any desired bandwidth of UV light that is appropriate for the compounds being analyzed in the capillary column 52. The first embodiment uses a 260 nm LED 40, but this wavelength of UV light may be changed as desired.

In this design, a commercially available 260 nm UV LED 40 with a first ball lens 42 was used as a light source. The LED 40 was mounted on the LED holder 44. The LED holder 44 was threaded into a black lens tube and held tight with the help of retaining rings. The first ball lens 42 may be 6 mm in diameter, or any appropriate size to focus the light from the LED 40.

FIG. 2 includes a band-pass filter 46 disposed after the first ball lens 42. The band-pass filter 46 may be a 260 nm band-pass filter used to reduce stray light from reaching a detector from the LED 40 and/or any surrounding light. The value of the band-pass filter may be adjusted as needed in order to be optimized for the LED 40 light source.

In the first embodiment, a 260 nm band-pass filter may be positioned in between the LED 40 and the second ball lens 42 in the black threaded tube.

Another element of the design may be the use of a second ball lens 48 disposed after the band-pass filter 46. The function of the second ball lens 48 may be to receive the UV light that is focused by the first ball lens 42 and focus the UV light even further. It is desirable to focus the UV light so that the light sent into the capillary column 52 may be equal to or smaller than the width of the inside diameter (ID). While it is preferred, the focusing of the UV light source may not be equal to or smaller than the ID of the capillary column 52 in the first embodiment.

In this design, a fused silica ball lens may have a 3 mm diameter for the second ball lens 48 and may be mounted on a 3 mm ball lens disk and may be disposed at the LED focal point. The second ball lens mount may be centered on a mount, which may be threaded into the black lens tube containing the LED 40 and the band-pass filter 46.

With increased light throughput through the capillary column 52 and received by the detector, it was experimentally determined that light intensity incident on the detector may be up to three orders of magnitude higher than prior art capillary LC designs.

To reduce stray light reaching the detector 54, one or more slits 50 are disposed after the second ball lens 48 and in front of the capillary column 52. The slits 50 may be provided by razor blades or any other appropriate device. The slits may be approximately 100 μm in width.

The combination of the band-pass filter 46 and the slits 50, stray light was experimentally reduced to a value of 3.6%, which is very low compared to prior art systems that may operate at reductions of stray light to a value 30.5%. Prior art designs may have either used special UV index photodiodes for higher wavelength stray light elimination which apparently were not very effective or may have used a slit (100 μm width) in front of 250 μm ID hollow capillary connected to the end of a commercial column (1 mm ID). This led to reduced light throughput through the capillary column 52. Furthermore, band broadening due to a connection between a larger diameter tube to a smaller diameter tube impairs detection sensitivity.

The UV light that passes through the capillary column 52 is positioned so that it strikes a UV detector 54. The UV detector 54 may be any UV sensitive device.

In this design, the UV detector 54 may be a silicon photodiode. The photodiode 54 may be disposed on a diode holder with external threads. A black cap may be built to thread into the diode holder. This black cap may have a V-shaped groove to hold the capillary column 52 in the center, a central hole to allow light passage, and grooves on opposite sides of the hole to hold the slits in place. A pair of razor blades may be used to fabricate the adjustable slit or slits 50. The slits 50 may be disposed on opposite sides of the central hole in the cap covering the outer diameter of the capillary column longitudinally.

In the detector 54, an operational amplifier may be used to receive the current from the photodiode and convert it into voltage values. An analog-to-digital converter may be used to record the voltage output with a computer or other recording device. It should be understood that a low pass RC filter may be used at the input to the analog-to-digital converter.

The examples to follow show experimental values for this design and should not be considered as limiting performance thereof. Data points were sampled at a rate of 1 KHz to 42 KHz. These data points were then smoothed at a 10 Hz rate to reduce the noise level in the detection system. These values should not be considered as limiting but serve to illustrate the principles of the embodiments of the invention. The data point sampling rate and data smoothing rate may be adjusted in order to optimize results for the detection system being used.

The LED 40 and silicon photodiode detector 54 may require 6 V and 12 V DC power, respectively, for operation. The detector 54 required 0.139 Amp current and could operate for approximately 25 hours using a 4 Amp-hour 12 V DC battery, as well as operate from line power with an AC to DC adapter. However, it should be understood that the detection system of this design may operate using a DC power source and therefore may be portable not only because of the DC power requirements, but because of the relatively small dimensions of the detection system.

An integrated stop-flow injector with an injection volume of 60 nL was used in these experiments, unless otherwise specified. A 150 μm ID×365 μm OD Teflon-coated capillary column 52 was used in all experiments. The absorbance values, where reported, were calculated by taking the common logarithm of the inverse of the transmittance values. The transmittance was calculated by dividing the sample signal by the reference signal obtained by recording the baseline.

Detector noise was determined over 1-min measurements of baseline data. A hollow fused silica capillary was connected to a nano-flow pumping system and filled with water. The baseline was then recorded for approximately 1 min, and the peak-to-peak absorbance was calculated. This gave the peak-to-peak (p-p) noise. Short term noise (RMS) was calculated as the standard deviation of the recorded baseline. For dark noise measurements, the LED 40 was turned off and the dark noise was measured as the standard deviation in the baseline. To determine digitizer noise, the positive and negative terminals of the A/D converter were shorted. Detector drift was determined by flowing water through the capillary at 300 nL/min and recording the baseline for 1 h, followed by measuring the slope of the baseline.

Software smoothing was performed to reduce the noise level. However, it should be understood that the smoothing function may be performed in hardware at a faster rate and may be substituted for the software smoothing. Although we can use a variety of smoothing techniques, the smoothing technique used in the first embodiment is fixed window averaging. Other smoothing techniques that may be used include but should not be considered as limited to, smoothing by averaging over a sliding window of fixed width, smoothing using an exponentially weighted moving average, and smoothing using a causal or non-causal filter constructed to whiten the baseline noise process.

Using a 150 μm ID capillary column 52 and 5.35 pmol injections of uracil in solution, the S/N ratio was determined at different smoothing rates, and the best smoothing rate was used for further work. The effect of RC filters (time constants of 0.5 s and 1 s) on short-term noise was also studied with and without performing any smoothing. A black ink-filled capillary was used for stray light assessment in the system. The stray light level was measured by dividing the voltage signal obtained for black-ink conditions by the voltage signal obtained with a water-filled capillary column 52, multiplied by 100.

The UV LED-based absorption detector 54 may be much smaller than a prior art Hg pen-ray lamp-based detector. For on-capillary column detection, absorbance values may be small, so noise reduction may be important to obtaining good detection limits. A bright light source LED 40 may increase the photocurrents used to calculate absorbances without proportional increase in noise. A single wavelength (260 nm) detector 54 was fabricated instead of a multi-wavelength detector in order to reduce the cost and size of the detection system.

Although the LED 40 had an integrated fused silica first ball lens 42 (6.35 mm diameter), which focused the light beam down to a 1.5-2.0 mm spot at the focal point (15-20 mm), this was still too broad for the capillary column 52 dimensions (0.075 to 0.20 mm ID). Therefore, the second fused silica ball lens 48 (3 mm diameter) was placed at the focal point of the LED 40 to obtain improved focusing of the light. The first and the second ball lenses 42, 48 may be constructed of any appropriate material.

The LED 40 was selected to emit light with a bandwidth of±5 nm; however, with a spectrometer, it was determined that the LED emitted light at higher wavelengths as well. The additional wavelengths of light may have contributed significantly to the stray light of the system.

A 260 nm band-pass filter with a FWHM of 20 nm was used during experimentation. The overlaid spectra in FIG. 6 show the light output from the LED 40 with and without the filter, confirming that the filter successfully eliminated the light from higher wavelengths. The LED 40 position was optimized to obtain the best focus at the center of the capillary column 52.

A feature of this design that is part of the functionality of the detector 54 is to perform processing of the detection data. In the experimental use of the first embodiment, the short-term RMS noise of the detector 54 was found to be 8 mV without the use of signal smoothing and low pass filter. The dark RMS noise without smoothing was calculated to be 6.95 mV. Software smoothing reduced the dark RMS noise level to 74.4 μV as shown in FIG. 7. The dark voltage values were the same in a lighted and dark room, confirming that the capillary column 52 did not act as a light guide. Digitizer noise can contribute significantly to the minimum noise obtainable with a detector. The digitizer RMS and p-p noise were found to be 2.4 mV and 7.7 mV, respectively. The effect of software smoothing on the digitizer RMS noise was studied as shown in FIG. 7 and the minimum RMS and p-p noise levels obtained were 15 μV and 95 μV, respectively.

The effect of software smoothing on the S/N ratio was also studied and, while it was found that the effect of smoothing on the signal intensity for peak widths in the chromatogram was negligible, the RMS noise level was reduced to a level of 0.18 mV in the voltage corresponding to intensity of incident light (Io) (5.7 μAU) without the use of a filter. With a 0.5 s filter and 4200 data points per 0.1 s smoothing, the RMS noise further dropped to 0.14 mV (4.4 μAU). Thus, the LED detector RMS noise was an order of magnitude lower (˜10-6 AU) than previous detectors and other UV LED detectors (˜10-5 AU). The detector 54 drift was found to be very low (10-5 AU per h), which may be negligible over a peak width and may present no problems for the duration of a typical chromatogram.

The linearity of a UV absorption detector may be compromised by improper focusing of the light source on the ID of the capillary column 54. Limits of detection depend on detector 54 short-term noise and the test analyte molar absorptivity. For the experiment, selection of test analytes was based on molar absorptivities and relevant previous LED detector work. The detector 54 gave a linear response up to the highest concentration tested, confirming that stray light was low in the system. The linear dynamic range was three orders of magnitude for all of the test analytes. The limit of detection at a S/N ratio of 3 was found experimentally to be 24.6 nM (7.63 ppb) or 1.5 fmol for SAS. This detection limit may be five times lower than a prior art pen-ray Hg lamp-based detector.

Since the detector 54 is specifically designed for on-column detection, the detector performance was tested under LC conditions using phenol and compared with the flow-through experiments as shown in Table 2. The detector linearity was excellent under both conditions, and the detection limits were found to be similar. Hence, the detector performance was not compromised when used under actual LC conditions.

Capillary LC is performed by the system shown in FIG. 1. Accordingly, the detection system includes a system for analyzing absorption of the UV light by at least one compound disposed in a liquid within the capillary column by analyzing the UV light that is received by the detector. The system for analyzing absorption may be part of the detector or may be a computer system that is coupled to the detection system for receiving data from the detector.

It is also noted that the system in FIG. 1 shows on-column LC detection using a monolithic capillary column. Using on-column detection may improve peak shapes and increase detection sensitivity because extra-column band broadening may be reduced.

The low detection limits of the system in FIG. 1 may be obtained for the test compounds due to the good light focusing, low stray light and very low noise in the capillary LC system. The detection limits for SAS in the capillary format with 150 μm pathlength may be 3 times lower than the LED-based detector with 1 cm pathlength. For AMP and DLT, the detection limits were improved by a factor of 230 and 60 in comparison with the detectors with the same pathlength. Also, phenol detection limits in our detector were the same under flow-through experiments and under separation conditions. Thus, detector performance was not compromised under actual liquid chromatography work. Reproducible isocratic separation of a phenol mixture was also demonstrated.

Software smoothing may be used to reduce the noise level in the detection system. Without smoothing, the total root mean square noise level was 8 mV. With the 4200 data points per 0.1 second smoothing, the noise level was reduced to 0.18 mV and when a low pass RC filter (2 Hz time constant) was employed to the input of the analog-to-digital converter, the noise further reduced to 0.14 mV (equivalent to 4.4 μAU). This is one of the lowest noise levels ever attained with capillary based detectors. Without software smoothing and using just the RC filter, the noise level was only reduced from 8 mV to 2.4 mV. Thus, low-pass filtering was clearly not enough to effectively eliminate high frequency noise from the detection system. The S/N ratio increased from 14 to 408 for 5.35 pmol uracil peaks. The noise level was up to 2 orders of magnitude smaller than the prior art in which some detectors only relied on a low pass filter.

A final comment regarding the size, weight, power requirements and portability of the system of FIG. 1 are a direct result of the uncomplicated design of the capillary LC system. A typical commercial system may have size dimensions of 11×13×22 cm, have a weight of 3.3 lbs., require a regular AC power line, and have a sensitivity that is approximately 1 mAU. In contrast, the system in FIG. 1 may have dimensions that are approximately 5.2×3×3 cm, may have a weight of 0.2 lbs., may operate from a 12 DC power source and only use 1.68 W, and may have a sensitivity of approximately 10 μAU. It should be understood that these values are approximate only and may vary up to 50% without departing from the characteristics of the first embodiment.

FIGS. 3 and 4 are provided as a second and third prior art system that may be used in the invention. Specifically, all features and functionality of the second and third systems are the same as the first system, with the exception of a change in the order of the first ball lens 42, the filter 46 and the second ball lens 48. FIG. 3 illustrates in a diagram that it may be possible to position the first ball lens 42 adjacent to the second ball lens 48, and to then eliminate the filter 46 entirely.

The filter 46 may eventually become unnecessary if the UV light source can be made more perfectly monochromatic. Filtering is performed in order to prevent any stray light from reaching the capillary column 54. If no or very little stray light is generated by the UV light source, then the filter becomes unnecessary and may be removed from the system without departing from the principles of the present invention.

In contrast, FIG. 4 illustrates in a diagram that it may be possible to position the filter 46 between the LED 40 and the first ball lens 42, and then position the second ball lens 48 adjacent to the first ball lens as in FIG. 3. In other words, it may be possible to dispose the filter 46 in front of both ball lenses 42, 48, and between the ball lenses, or eliminate the filter entirely and still achieve the desired focusing and filtering of the UV light from the LED 40.

### BRIEF SUMMARY

The present invention is a system and method for performing UV LED-based absorption detection for capillary liquid chromatography for detecting and quantifying compounds in a liquid, wherein a simplified system eliminates the need for a beam splitter and a reference cell by using a stable UV source, and power requirements are reduced, resulting in a portable and substantially smaller system with relatively low detection limits.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a first diagram of a first prior art system that may be modified to function as part of the present invention and shows the major hardware elements of a capillary LC system.

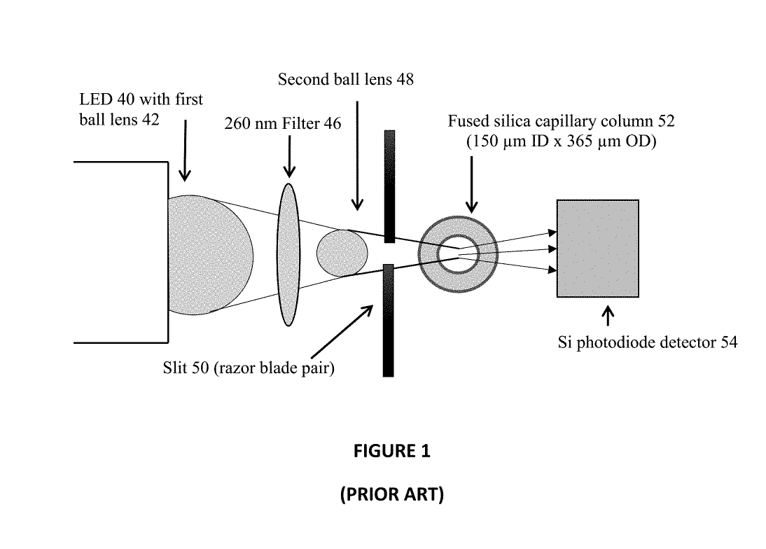

FIG. 2 is a second diagram of the system of FIG. 1 showing more construction detail of a capillary LC system.

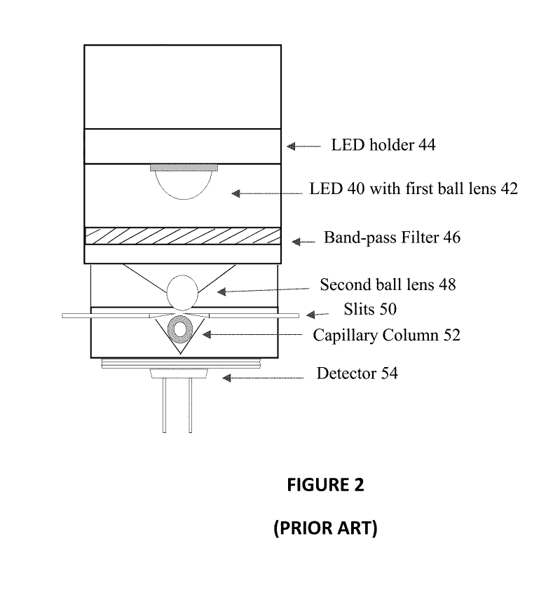

FIG. 3 is a diagram of the components in a modified system of FIG. 1.

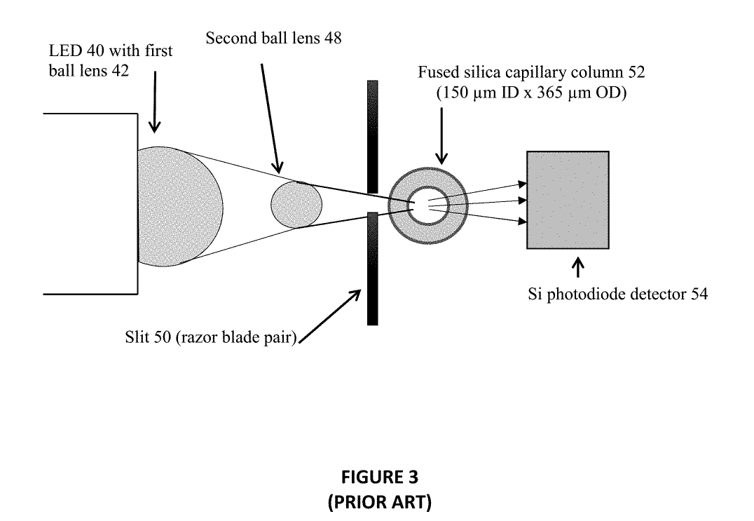

FIG. 4 is a diagram of the components in a different modified system of FIG. 1.

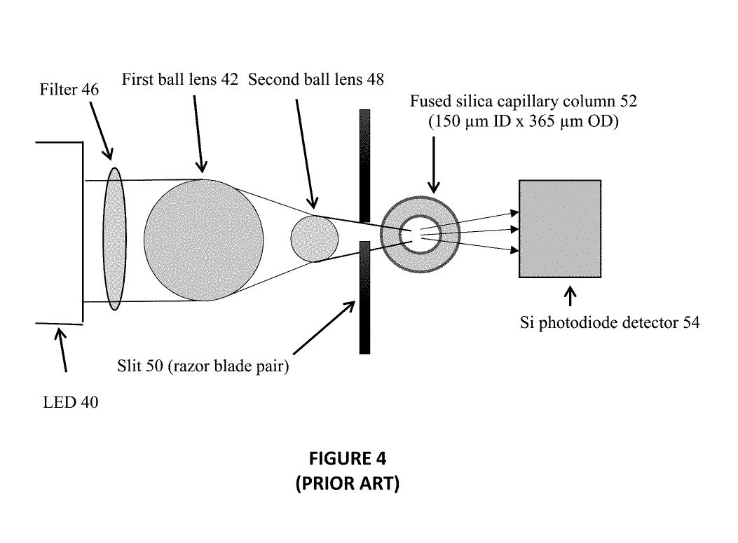

FIG. 5 is a diagram of a first embodiment of the invention.

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention and should not be viewed as narrowing the claims which follow.

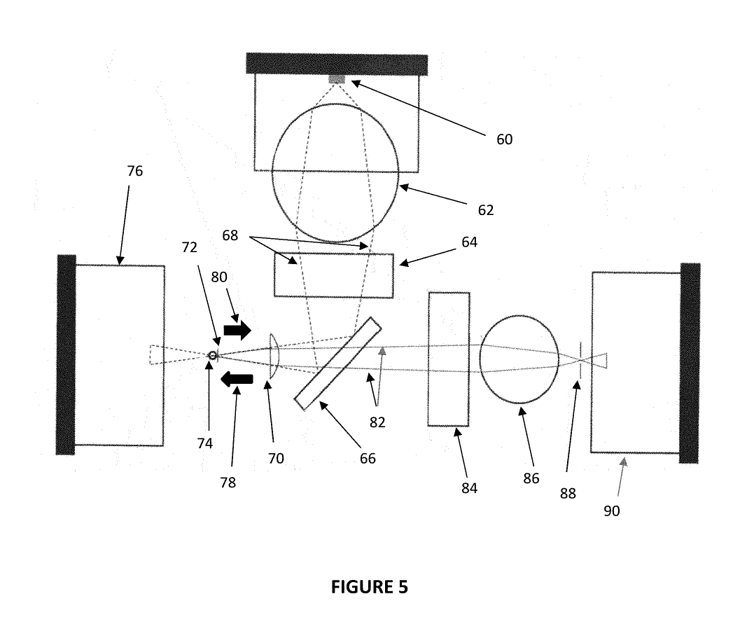

FIG. 5 is a diagram of a first embodiment of the invention. This first embodiment combines fluorescence and spectrophotometric (absorption) detection in a single compact system that is suitable for on-column detection with capillary column-based separations.

There are two detection channels in the system. The first detection channel is an absorption channel that includes all of the elements in a path of UV light from a light-emitting diode (LED) light source to an absorption detector. An absorption channel is based on the design shown in the prior art. However, the absorption channel may be modified in order for a second detection channel to be added to the system.

The second detection channel is a fluorescence channel that includes all of the elements in a path of UV light from the LED light source to a fluorescence detector.

Detection of the at least one compound in the capillary column is based on on-column absorbance at over a selectable wavelength band, depending on the combination of LED selection and bandpass filter placed between the LED and the capillary column.

Adding the fluorescence channel to the prior art absorption detector incorporates several unique features that were not part of any previous dual detector designs. Before these unique features are identified, the elements of the two detection channels will be described.

The elements of the first embodiment that are the same as the elements of the prior art may also have the same features and characteristics as described above. The elements of the system in FIG. 5 include a UV-based LED 60, a first ball lens 62, and an excitation (band-pass) filter 64 that may be tuned to the LED 60 light source. A new feature of the first embodiment is necessary in order to provide the two detection channels. The new feature is a dichroic mirror 66. It may also be referred to as a long-pass dichroic mirror 66 or dichroic beam splitter as understood by those skilled in the art. The dichroic mirror 66 enables the first embodiment to have the dual detector channels operate simultaneously.

The dichroic mirror 66 substantially reflects all of the UV light from the UV-based LED 60 in a first direction that may be at approximately a right angle to the path traveled from the source LED 60. The absorption channel light path is indicated by the dotted lines 68.

The UV light is reflected off the dichroic mirror towards a second lens 70. The second lens 70 may be a convex lens in order to focus the UV light.

After the second lens 70 may be a slit 72 that may be comprised of razor blades, a capillary column 74 that may have an inner diameter (ID) of approximately 150 μm and an outer diameter of approximately 365 μm, and a silicon photodiode detector 76. That description completes all of the elements of the absorption channel in the system.

The fluorescence channel begins using the same UV-based LED 60, the first ball lens 62, and the excitation filter 64 that may be tuned to the LED 60 light source. The dichroic mirror 66 is also used to send the UV light in a first direction 78 through the second lens 70, the slit 72 and into the capillary column 74.

However, at this point the path of light diverges. One or more compounds in the capillary column 72 may fluoresce and give off a light that will be referred to hereinafter as “fluorescence light”. The fluorescence light that is being measured travels in the opposite direction to the first direction 78 as a second direction 80.

The fluorescence light is focused by the second lens 70 as shown by lines 82 so that it passes through the dichroic mirror 66. An emission filter 84 may filter the fluorescence light before it passes through a third lens 86 which focuses the fluorescence light through a slit or pinhole 88 and into a fluorescence detector 90.

Some of the unique features of the first embodiment include the same UV LED 60 is used for both detection channels. The desirable properties of the LED 60 are compact size, low power consumption, high spectral irradiance, low cost, and stable output power. It is the stable output of the LED 60 that enables the absorption part of the system to operate without a reference channel. That same stability may also be essential for low-noise fluorescence detection because the fluorescence signal depends directly on the radiant flux hitting the sample.

Another features is that the second lens 70 that focuses the light from the LED 60 into the capillary column 74 is also used as the primary collection optic for the fluorescence detector 90. An epi illumination scheme ensures that the addition of the fluorescence channel to the absorption detector 76 does not in any way degrade the performance of the absorption detector.

A third feature of the first embodiment is that the incoming excitation radiation from the LED 60 and the outgoing fluorescence light from the at least one compound in the capillary column 74 are separated by the dichroic mirror 66 which also functions as a beam splitter may reflect the excitation wavelengths of the LED 60 and reflect the fluorescence wavelengths of the fluorescence light.

The combining of the two optical paths 68, 82 of the absorption channel and the fluorescence channel ensures that both detectors 76, 90 are responding to the same small volume in the capillary column 74.

A fourth feature is that after the two light paths 68, 82 are separated, one or more optical filters 84 may be placed in the fluorescence emission path 82 to discriminate against residual excitation light and to add a degree of specificity for selected classes of compounds in the capillary column 74. The wavelength difference between the excitation radiation from the LED 60 and the peak of the fluorescence signal depends on the electronic structure of the fluorescing molecule, so different excitation wavelength and emission filter combinations may be used to target specific classes of compounds.

In an alternative embodiment of the invention, the emission filter 84 and fluorescence detector 90 in the fluorescence emission path 82 may be replaced by a compact spectrometer that may record an entire fluorescence spectrum.

It is observed that both the emission channel and the absorption channel may be monitored simultaneously and continuously. Each channel may provide a measure of analyte concentration, with differing sensitivities, depending on the electronic structure of the analyte molecule. The ratio of the fluorescence to the absorbance is, to a first approximation, independent of concentration. Rather it may be a measure of fluorescence quantum yield, and it may provide a molecular signature that is not available through either detection channel by itself. In the first embodiment of the invention that incorporates a spectrometer in the emission channel, the recorded spectra may provide information about eluting analytes that aids in analyte identification.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A combined fluorescence detector and absorption detector system for on-column detection after using capillary separation techniques, said system comprising:
an LED for generating a UV light;
a first lens for focusing the UV light from the LED;
a dichroic mirror for reflecting the UV light in a first direction;
a second lens for focusing the UV light in the first direction;
a capillary column for receiving the UV light to thereby enable on-column detection;
an absorption detector for receiving the UV light that has passed through the capillary column and performing absorption detection;
the dichroic mirror now passing light that is emitted by fluorescence from one or more compounds within the capillary column, the fluorescence light moving in a second direction opposite the first direction;
a third lens for focusing the fluorescence light in the second direction; and
a fluorescence detector for receiving the fluorescence light and performing fluorescence detection.

2. The system as defined in claim 1 wherein the system further comprises an excitation filter disposed between the first lens and the dichroic mirror for filtering the UV light.

3. The system as defined in claim 1 wherein the system further comprises at least one slit for passing the UV light received from the second lens in the first direction and disposed for reducing stray light from entering the capillary column.

4. The system as defined in claim 3 wherein the system further comprises an emission filter disposed between the dichroic mirror and the third lens for filtering the fluorescence light.

5. The system as defined in claim 4 wherein the system further comprises at least one slit or pinhole for passing the fluorescence light received from the third lens in the second direction and disposed for reducing stray light from passing through.

6. The system as defined in claim 5 wherein the absorption detector is further comprised of a system for analyzing absorption of the UV light by at least one compound disposed within the capillary column by analyzing the UV light that is received by the absorption detector.

7. The absorption detector as defined in claim 6 wherein the absorption detector is further comprised of:
a photodiode for receiving the UV light from the capillary column;
an operational amplifier for receiving current from the photodiode and converting it into voltage values; and
an analog-to-digital converter for receiving the voltage values from the operational amplifier and converting it into digital values.

8. A method for combining fluorescence detection and absorption detection in a detection system for performing on-column capillary detection after using capillary separation techniques, said method comprising the steps of:
providing a light emitting diode (LED), a first lens for receiving and focusing the UV light from the LED, a dichroic mirror for reflecting the UV light in a first direction, a second lens for focusing the UV light in the first direction, at least one slit for passing the UV light received from the second lens in the first direction, a capillary column for receiving the UV light, and an absorption detector for receiving the UV light that has passed through the capillary column and performing absorption detection;
providing the dichroic mirror that is passing light that is emitted by fluorescence from one or more compounds within the capillary column, the fluorescence light moving in a second direction opposite the first direction, a third lens for focusing the fluorescence light in the second direction, and a fluorescence detector for receiving the fluorescence light and performing fluorescence detection;
generating the UV light from the LED;
measuring the UV light that passes through the capillary column by using the absorption detector;
analyzing absorption of the UV light by the at least one compound within the capillary column by analyzing the UV light that is received by the detector;
passing the fluorescence light from the capillary column through the dichroic mirror;
measuring the fluorescence light from the at least one compound in the capillary column; and
analyzing absorption of the fluorescence light by the at least one compound within the capillary column by analyzing the fluorescence light that is received by the fluorescence detector.

9. The method as defined in claim 8 wherein the method further comprises:
disposing an excitation filter between the first lens and the dichroic mirror; and
filtering the UV light from the first lens.

10. The method as defined in claim 9 wherein the method further comprises providing at least one slit for passing the UV light received from the second lens in the first direction; and
reducing stray light from entering the capillary column.

11. The method as defined in claim 10 wherein the method further comprises:
disposing an emission filter between the dichroic mirror and the third lens; and
filtering the fluorescence light from the dichroic mirror.

12. The method as defined in claim 11 wherein the method further comprises:
providing at least one slit or pinhole for passing the fluorescence light received from the third lens in the second direction; and
reducing stray light from passing through at least one slit or pinhole.

13. The method as defined in claim 12 wherein the method further comprises providing a system for analyzing absorption of the UV light by the at least one compound within the capillary column by analyzing the UV light that is received by the absorption detector.

14. The method as defined in claim 8 wherein the method further comprises increasing the amount of the UV light received by the detector by at least two orders of magnitude.

15. The method as defined in claim 8 wherein the method further comprises:
selecting a wavelength of the UV light generated by the LED; and
selecting the excitation filter to match the wavelength of the UV light generated by the LED to thereby reduce stray light from reaching the capillary column.

16. The method as defined in claim 8 wherein the method further comprises positioning the second lens relative to the dichroic mirror such that a focal point of the UV light from the second lens is equal to or less than an inside diameter (ID) of the capillary column.

17. The method as defined in claim 6 wherein the method further comprises:
providing a photodiode in the absorption detector, providing an operational amplifier for receiving current from the photodiode and converting it into voltage values and providing an analog-to-digital converter for receiving the voltage values from the operational amplifier.
receiving the UV light from the capillary column at the photodiode;
converting the UV light into voltage values using the operational amplifier; and
converting the voltage values into a digital signal.

18. The method as defined in claim 10 wherein the method further comprises the step of providing power to the LED, the absorption detector and the fluorescence detector using a DC power source to thereby enable the detection system to be portable.

19. A combined fluorescence detector and absorption detector system for on-column detection after using capillary separation techniques, said system comprising:
an LED for generating a UV light;
a system of lenses, a mirror and a slit for directing and focusing the UV light;
a capillary column for receiving the UV light to thereby enable on-column detection;
an absorption detector for receiving the UV light that has passed through the capillary column and performing absorption detection;
the dichroic mirror also passing light that is emitted by fluorescence from one or more compounds within the capillary column, the fluorescence light moving in a second direction opposite the first direction;
a third lens and a slit for directing and focusing the fluorescence light in the second direction; and
a fluorescence detector for receiving the fluorescence light and performing fluorescence detection.

20. A method for combining fluorescence detection and absorption detection in a detection system for performing on-column capillary detection after using capillary separation techniques, said method comprising the steps of:
providing a UV light source, a system of lenses, a dichroic and a slit for directing the UV light in a first direction, a capillary column for receiving the UV light, and an absorption detector for receiving the UV light that has passed through the capillary column and performing absorption detection;
providing the dichroic mirror that is passing light that is emitted by fluorescence from one or more compounds within the capillary column, the fluorescence light moving in a second direction opposite the first direction, providing a third lens and a slit for directing and focusing the fluorescence light in the second direction, and a fluorescence detector for receiving the fluorescence light and performing fluorescence detection;
generating the UV light from the LED;
measuring the UV light that passes through the capillary column by using the absorption detector;
analyzing absorption of the UV light by the at least one compound within the capillary column by analyzing the UV light that is received by the detector;
passing the fluorescence light from the capillary column through the dichroic mirror;
measuring the fluorescence light from the at least one compound in the capillary column; and
analyzing absorption of the fluorescence light by the at least one compound within the capillary column by analyzing the fluorescence light that is received by the fluorescence detector.
